(19) United States
(12) Patent Application Publication
(10) Pub. No.: US 2023/0196268 A1
(43) Pub. Date: Jun. 22, 2023

(54) FACILITATING SECURE DELIVERY OF PRODUCTS AND/OR SERVICES

(71) Applicant: Davut Kavranoglu, Istanbul (TR)

(72) Inventor: Davut Kavranoglu, Istanbul (TR)

(21) Appl. No.: 17/926,840

(22) PCT Filed: Jun. 14, 2021
(86) PCT No.: PCT/US21/37281

§ 371 Date: Nov. 21, 2022

Related U.S. Application Data
(60) Provisional application No. 63/039,022, filed on Jun. 15, 2020.

(51) Int. Cl. G06Q 10/0835; G06Q 20/38

(52) U.S. Cl. CPC G06Q 10/0835; G06Q 20/3821; G06Q 2220/00

(57) ABSTRACT

Provided is a system for facilitating secure delivery of products and/or services to a user, including fraud prevention. The system includes a plurality of agents, a network of Trusted Delivery Agents (TDAs) selected from the plurality of agents proximate to a delivery location of the user, a network of Trusted Financial Agents (TFAs) selected from a group of financial institutions, and an information sharing module configured to enable delivery of multi-dimensional information including TDA IDs to one or more agents of the plurality of agents. Each agent of the plurality of agents maintains the multi-dimensional information as pre-computed knowledge/experience and propagates the pre-computed knowledge/experience to one or more neighboring agents of the plurality of agents. A TFA selected by the user is configured to carry out financial transactions/services between the user and one or more agents on behalf of the user.

### RELATED APPLICATIONS

This patent application is a U.S. National Stage application of International PCT Patent Application No. PCT/US21/37281 to Kavranoglu, filed Jun. 14, 2021, which claims the benefit of priority to U.S. Provisional Patent Application No. 63/039,022, filed on Jun. 15, 2020, entitled “METHOD AND SYSTEM FOR SECURE DELIVERY OF PRODUCTS AND SERVICES,” the entire disclosure of which is incorporated herein by reference in its entirety and for all purposes.

### FIELD

Various embodiments of the present disclosure generally relate to secure delivery of products and/or services in a delivery industry. Specifically, the present disclosure relates to a system for facilitating secure delivery of products and/or services in the delivery industry by addressing the many challenges faced by the delivery industry which may include, but are not limited to, deficiencies in existing address conventions, the First Mile and the Last Mile problems, diverse delivery requests, personal problems/issues in online purchase and delivery systems, drawbacks in identity-based access systems/ticketing systems and changing delivery technologies.

### BACKGROUND

The delivery services, or courier services or package/parcel delivery services are part of an industry segment called the delivery industry, which primarily engages in delivery services of packages and/or parcels between urban centers, and to a limited extent covering rural areas as well, using a network of air, sea and surface transportation systems. The delivery industry has been one of the most crucial enabling industries for development of international trade and direct to consumer sales in the world. Especially after the beginning of the Internet age starting from early 1990s, people around the world enjoy the conveniences brought by the Internet for shopping and receiving other services online.

The natural result of online shopping is a fast-increasing demand for the delivery of parcels from online sellers to buyers, where the delivery industry acts as an enabler for online shopping companies. Online shopping companies are increasingly playing a more direct role in delivery services not only to meet their delivery needs but also to have a competitive advantage by differentiating their overall services and offerings.

A particular problem of the delivery industry is the limitation involved in sharing user identity and information needed to facilitate exchange/delivery of goods and services. Delivery information generally involves identifying a user by the user's basic personal information which includes the user's phone number, credit card information and postal address. This information is manually provided by the user to a courier service provider, for example, and is disclosed to a chain of delivery agents. The courier service provider then delivers the goods or services based on the information shared by the user.

Furthermore, existing street address conventions are built on the premise that an end user is to be identified using his location information shared for each individual shipment. The service provider does not have access to any other relevant and useful information other than the location of the end user.

Similarly, state-of-the-art method of sharing digital coordinates is just another method of sharing only location information, which is just a more modern version of sharing a person's location using Global Positioning System (GPS) coordinates, rather than using street names and building numbers. The only information the person can share is his “address”, which is nothing but the user's location. For instance, using conventional systems, a user cannot share available time information in a location to enable a delivery agent of a courier service to deliver parcel/shipment to the user's location based on the user's availability, such as, for example, the user is available at this address between 1-3 pm, so that when the courier/delivery agent arrives at that location, the user/customer is available to receive the shipment.

Furthermore, the user cannot share multiple locations with other people labeled with available time information in a scheduled manner, so that a delivery agent can make an optimal schedule to make a delivery by identifying the user's location. Also, the existing address conventions do not allow sharing coordinates (based on GPS, GLObal NAvigation Satellite System (GLONASS), Galileo or other positioning systems) for a fixed location or a set of locations, or for continuously changing locations, three-dimensional (3D) coordinates or four-dimensional (4D) coordinates, where time is the fourth dimension.

In the current scenario, with the advancement of technologies, mobile devices with GPS, or other positioning systems such as, but not limited to, land-based triangulation systems or Galileo, and GLONASS and navigation capabilities and the Internet have seen widespread use and adoption. These are not a part of the address convention/standard. As such they are not being effectively used as part of shipping/receiving and delivery systems. Furthermore, there is no information sharing standard or system exploiting these technologies effectively in delivery and logistics systems and securely sharing relevant/useful information with concerned parties.

Further, the delivery industry encounters issues such as the First Mile and the Last Mile problem, which is a significant cost element for the delivery industry.

Furthermore, there is a lack of efficient identity-based access/ticketing systems. For instance, using currently existing access systems, visiting people in buildings with gate control is quite cumbersome. Conventionally, this is how it works: A visitor goes to the front desk of a building and talks to the receptionist to tell them which person in the building he/she wants to visit. The receptionist asks for a photo-ID from the visitor. The receptionist then calls the requested person to be visited and asks him/her if he would like the visitor to be allowed to pass the controlled entry to visit them. If the visitor is verified, the receptionist provides the visitor a visitor's pass. The visitor completes the visit and goes back to the receptionist to return the visitor's pass and receives his own photo-ID. This process of access check and control for entry is laborious and is not quite reliable.

Therefore, there exists a need for an improved system which addresses the aforesaid challenges/issues of the delivery industry while ensuring secure delivery of products and/or services to a consumer/recipient.

### SUMMARY

A system for facilitating secure delivery of products and/or services is provided substantially as shown in and/or described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a diagram that illustrates a system for facilitating secure delivery of products and/or services to a user in accordance with an exemplary embodiment of the disclosure.

FIG. 2 is a flowchart of a process for addressing the First Mile problems in the delivery industry in accordance with an exemplary embodiment of the disclosure.

FIG. 3 is a flow diagram illustrating a process of private purchase and delivery in a delivery industry in accordance with an exemplary embodiment of the disclosure.

FIG. 4 is a diagram that illustrates a three-dimensional (3D) navigational and addressing schema for enabling delivery of 3D coordinate and time information in accordance with an exemplary embodiment of the disclosure.

FIG. 5 is a flowchart that illustrates a method for facilitating secure delivery of products and/or services to a user using the system in accordance with an exemplary embodiment of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION

The following described implementations may be found in the disclosed system for facilitating secure delivery of products which include, but are not limited to, shipments, packages and parcels, and/or services to a user by addressing the many challenges faced by a delivery industry such as, but not limited to, deficiencies in existing address conventions, the First Mile and the Last Mile problems, diverse delivery requests, personal problems/issues in online purchase and delivery systems, drawbacks in identity-based access systems/ticketing systems, and changing delivery technologies (for example, drone deliveries).

The system of the present disclosure includes a plurality of agents to facilitate delivery of one or more products and/or services to the user, a network of Trusted Delivery Agents (TDAs), the network of TDAs selected from the plurality of agents proximate to a delivery location of the user, a network of Trusted Financial Agents (TFAs), the network of TFAs selected from a plurality of financial institutions, and an information sharing module. the plurality of agents may include, but are not limited to, one or more service providers, electronic retailers or e-retailers, marketplace, e-stores, delivery agents, TDAs, TDA networks, other users, non-users, vehicles, machines, vessels, mobile devices, service providers, vehicle drivers, automation services, freight services, inhouse storage and concentration centers or combinations thereof

The network of TDAs is selected from a group consisting of existing neighborhood small businesses, a household, a mobile distribution network, a business started for this purpose or any local qualified party willing to be assigned as TDA, proximate to a delivery location of the user.

The network of TDAs acts as an integral part of common parcel and other delivery services, wherein the network of TDAs takes over the First Mile and the Last Mile of a delivery supply chain.

In accordance with an embodiment, a TDA enables transfer/delivery of cash from the user's funds transfer account to a recipient, wherein the funds transfer account is at least one of a credit card account, a bank account, a debit card account, a gift card account or any other similar financial services.

The network of TFAs is selected from a group consisting of existing banks, financial institutions, and special businesses started up to conduct financial transactions on behalf of the user.

A TFA is triggered to settle a payment on behalf of the user in reference to a transaction code, wherein the TFA settles the payment without disclosing the user's identity or personal financial information and in response, charges an account of the user. at the account may include, but is not limited to, a credit card account, a bank account, a debit card account, a gift card account or any other similar financial services. The transaction code is generated by an agent and comprises information pertaining to the user, an amount for the payment and a smart contract that includes terms of payment released to the recipient.

In accordance with an embodiment, the system further includes a Blockchain and a contract-based system for facilitating financial settlements using digital tokens. One or more contracts are established between the user and one or more of the plurality of agents. In an embodiment, a contract is established as a smart contract.

The information sharing module is configured to enable delivery of multi-dimensional information to one or more agents of the plurality of agents. The delivery of the multi-dimensional information includes delivery of at least one of pictures, videos, waypoints, experiences of previous agents, written or audio explanations, time of availability or approach vector information of an address or location, navigation and guidance information on how to reach agents at any given time instant or combinations thereof. Each agent of the plurality of agents maintains the multi-dimensional information as pre-computed knowledge/experience and propagates the pre-computed knowledge/experience to one or more neighboring agents of the plurality of agents. In accordance with an embodiment, the system of the present disclosure further includes an Artificial Intelligence (AI)/Machine Learning (ML) component configured to utilize previous data to determine knowledge/experience of previous users to facilitate delivery of the one or more products and/or services to the user.

In accordance with an embodiment, the information sharing module is configured to deliver 3D coordinate and time information using a 3D navigational and addressing schema. The 3D navigational and addressing schema stores at least one of navigational directions and/or movement vectors from one location to another in a series of addressing components. The series of addressing components comprises a 2D component, a height and story component and an angle of approach component for drones and other vehicles. The height and story component includes information pertaining to a height and a number of stories in a building to be addressed with each story level. The angle of approach component for drones and other vehicles comprises planar movement definition for a series of moves in case of a need for stabilization or an approach angle to a building or a moving object. The angle of approach component comprises information pertaining to an angle for any movement towards a specific movement vector through an angle of perimeter and height.

The information sharing module is further configured to share at least one TDA ID, wherein a TDA ID comprises information corresponding to a TDA selected by the user from the network of TDAs. A TFA is then selected by the user from the network of TFAs integrated in the system, wherein the TFA is configured to carry out financial transactions and/or financial services between the user and one or more agents on behalf of the user.

In accordance with another embodiment, the system of the present disclosure further includes an access system configured to control entry of an agent into the user's premises, wherein the access system is configured to generate a one-time pass to enable the agent to enter the user's premises to deliver a product and/or service, wherein the one-time pass is associated with a time period for entry of the agent.

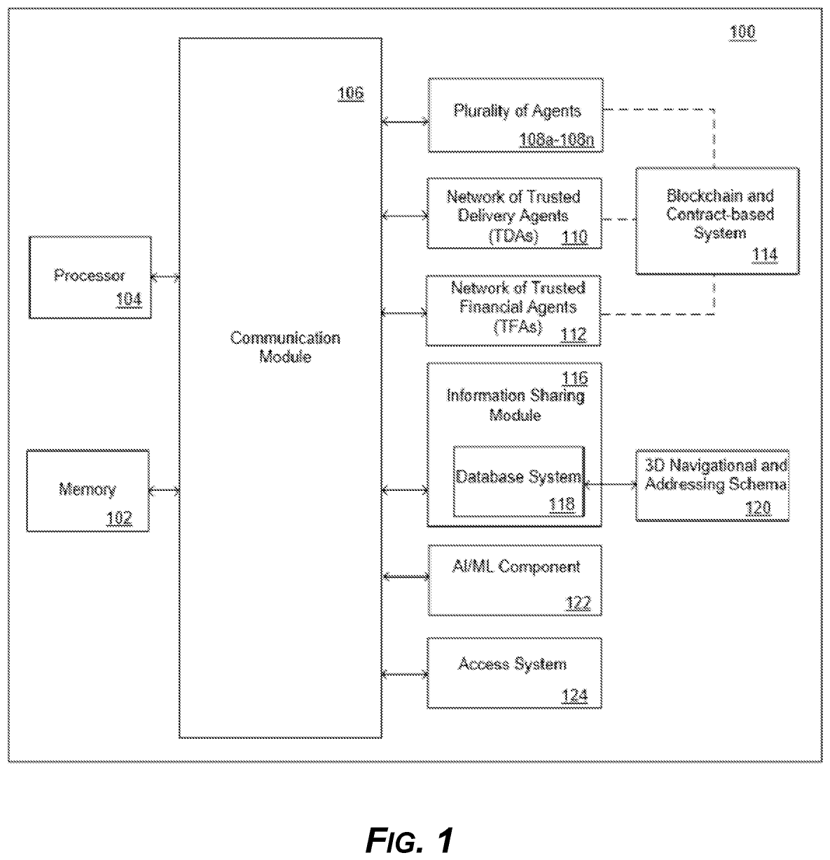

FIG. 1 is a diagram that illustrates a system for facilitating secure delivery of products and/or services to a user in accordance with an exemplary embodiment of the disclosure. Referring to FIG. 1, there is shown a system 100, which includes a memory 102, a processor 104, a communication module 106, a plurality of agents 108a-108n, a network of TDAs 110, a network of TFAs 112, a Blockchain and contract-based system 114, an information sharing module 116, a database system 118, a three-dimensional (3D) navigational and addressing schema 120, an Artificial Intelligence (AI)/Machine Learning (ML) component 122 and an access system 124.

The memory 102 may comprise suitable logic, and/or interfaces, that may be configured to store instructions (for example, computer readable program code) that can implement various aspects of the present disclosure.

The processor 104 may comprise suitable logic, interfaces, and/or code that may be configured to execute the instructions stored in the memory 102 to implement various functionalities of the system 100 in accordance with various aspects of the present disclosure. The processor 104 may be further configured to communicate with various modules of the system 100 via the communication module 106.

The communication module 106 may comprise suitable logic, interfaces, and/or code that may be configured to transmit data between modules, engines, databases, memories, and other components of the system 100 for use in performing the functions discussed herein. The communication module 106 may include one or more communication types and utilizes various communication methods for communication within the system 100.

The plurality of agents 108a-108n may include, but are not limited to, one or more service providers, electronic retailers or e-retailers, marketplace, e-stores, delivery agents, TDAs, TDA networks, other users, non-users, vehicles, machines, vessels, mobile devices, service providers, vehicle drivers, automation services, freight services, inhouse storage and concentration centers or combinations thereof, for facilitating delivery of one or more products and/or services to a user in a delivery industry. The user may be, but is not limited to, a customer, a service provider such as, but not limited to, a courier/postal/delivery service provider and a seller/vendor.

In an instance, the plurality of agents 108a-108n enable delivery of products and/or services that may include, but are not limited to, physical goods, packages, parcels, shipments, credit cards, digital goods, digital messages, and digital currency, from service providers to recipients/consumers through a chain of delivery/courier agents.

The network of TDAs 110 acts as an integral part of common parcel and other delivery services and takes over the First Mile and the Last Mile of a delivery supply chain. The network of TDAs 110 is selected from a group consisting of existing neighborhood small businesses, a household, a mobile distribution network, a business started for this purpose or any local qualified party willing to be assigned as TDA, proximate to a delivery location of the user.

The TDAs serve as the First Mile and the Last Mile delivery agents for courier companies, and thus provide a solution for the First Mile and the Last Mile delivery problem in a parcel/shipment delivery industry and for the same day delivery issues.

The network of TDAs 110 are appointed by consumers to make their final deliveries for them. By sharing their identities, consumers identify themselves uniquely by selecting “TDAs” in their neighborhood. Ordinarily, these TDAs are existing neighborhood small businesses that the consumers customarily utilize for their daily needs, such as, but not limited to, a neighborhood grocery store, a gas station, a bakery, or a store started up just to serve as a TDA. A consumer's exact delivery information is made available to the TDA or the TDA naturally has such knowledge about the consumer since they are in the same neighborhood. Thus, the network of TDAs 110 is a system built to solve the First Mile and the Last Mile problems. Further, the TDAs are primarily selected by recipient consumers and not by the delivering courier services.

In an embodiment, the network of TDAs 110 enables money transfer or cash delivery from banks of consumers to the consumers or from one consumer to another. Thus, the network of TDAs 110 replaces the ATM cash delivery system for the banks.

In accordance with an exemplary embodiment, the system 100 employs the following key elements to facilitate delivery services using the network of TDAs 110: a system of identity sharing, a TDA, and a communications and delivery protocol among the delivery courier services, the recipient, and the TDA. The process involved is summarized as follows.

A consumer asks a courier company for delivery of their packages to be delivered to a “final address”, using TDAs. The courier company makes final deliveries to the very same TDAs every day, hence, there is no time consumed to search for the location and person who will serve as the TDA for delivery of the packages.

Once the system 100 has the consumers, TDAs, courier companies and online shopping sites, the shipping process begins from the online shopping sites and is finalized in a TDA or alternatively, the shipping process starts from a consumer and is finalized in a TDA for the receiving consumer.

During the execution of an online purchase and shipping process, three contracts are entered into:

The contract between the consumer and an online seller: This contract includes the item purchased and a corresponding payment to be made and the courier company is allowed to pick up the package after the payment is done. Unless the consumer returns the purchased goods for some reason, the contract is fulfilled when the package is delivered to the courier company.

The contract between the consumer and a courier company: This contract includes picking up the package from the seller (or the sender in case it is a consumer-to-consumer shipment) after the ordering consumer makes the payment. The contract is fulfilled when the courier company delivers the package to the TDA of the consumer.

The contract between the consumer and TDA: This contract indicates that a TDA receives the goods from the courier company on behalf of the consumer and is responsible for the security of the package after the package is received by the courier company. The TDA's contract is fulfilled when the consumer either picks up the package from the TDA or the TDA delivers the goods to the consumer upon their request through the system 100.

As soon as the package is delivered to the TDA, the courier company fulfills its “contract” with the consumer for delivery since the consumer asked for the delivery to be made to the TDA. At that moment, the consumer is messaged through the system 100 that their package has been delivered to the TDA as per their demand. The consumer can opt to ask the TDA to deliver the package to their location, which is known by the TDA or the consumer can directly pick up the package from the TDA. At this stage of the delivery process, the “contract” between the TDA and the consumer is in effect. All these contacts are entered into through the system 100 of the present disclosure.

If in case a consumer is not happy about the shipment they received and wishes to return the shipment, the consumer can hand it over to the TDA and the TDA delivers the returned parcel to the courier company in their first service when bringing new deliveries to them. Similarly, if the consumer wishes to send a new outgoing shipment, the consumer delivers it to the TDA with the final delivery information and the TDA delivers the parcel as per the consumer's demand. The consumer can also request the TDA to send their package using a specific courier company or they could leave the choice to the TDA to pick a courier company, in which case the TDA considers several criteria which include, but are not limited to, cost, service quality and other incentives provided by the courier company to the TDA and the consumer.

There may also be cases where the consumer may not want to pick TDAs for their deliveries. In such cases, the TDAs may be available to offer their services to the courier companies for a service fee to make deliveries on behalf of the courier companies under their brand.

Every day, TDAs receive new incoming shipments for their customers as a bulk shipment from each courier company. The TDAs also hand in the return parcels and the new outgoing shipments to courier trucks that brought in the new parcels. Such a process is repeated by every courier company with the same TDAs, that is, the TDAs act as common delivery agents for all competing courier services. As the demand for same day delivery increases, delivery by courier companies through the TDAs is repeated several times every day.

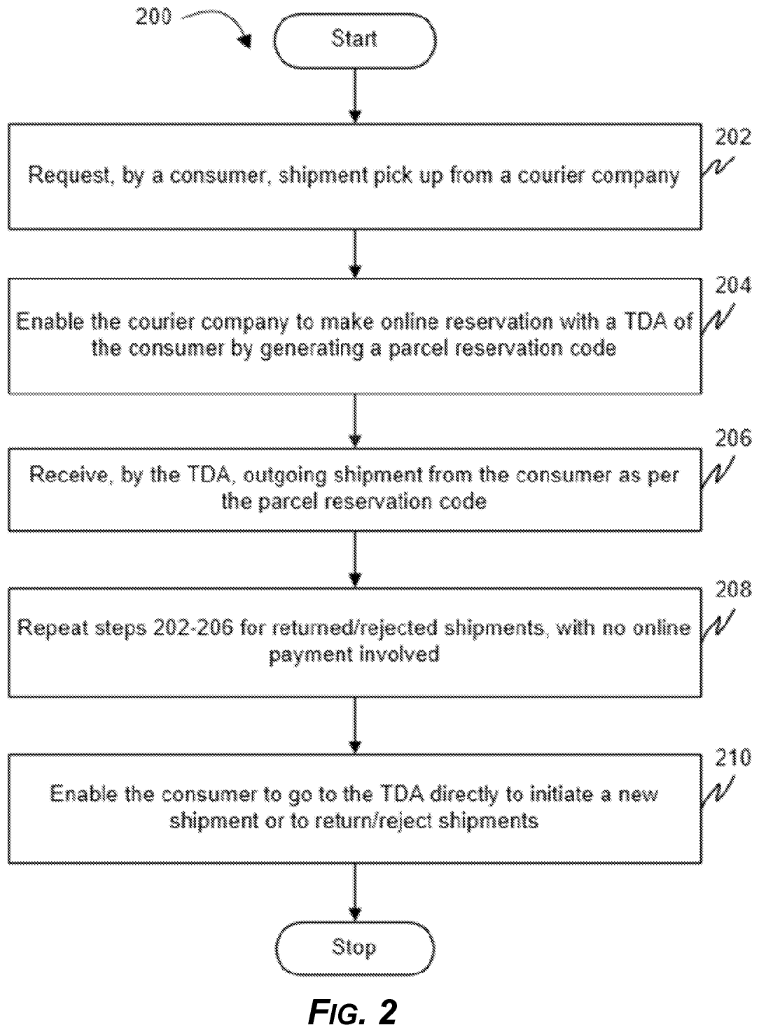

In an embodiment, the First Mile Problem is resolved for a group of cases. In one case, the First Mile problem that is dealt with is that when the consumers wish to initiate a shipment, they need to go to the collection points or stores of courier companies, which is mostly undesirable for consumers. On the other hand, going out to pick up a new shipment or a returned/refused shipment is a very costly process for the courier companies. A straightforward method of solving this First Mile Problem is to use TDAs as pick-up points for the new shipments and returned/refused shipments. This process is further explained in conjunction with FIG. 2.

TDA partners are authorized by users of the system 100 to pick up and make the First Mile and the Last Mile delivery to the users for a minimal service charge, which is much less than their cost for the First Mile and the Last Mile. TDA partners then derive a financial benefit from end users of the system 100 from the courier service industries (FedEx, DHL, UPS, ATS), since they are taking over the First Mile and the Last Mile responsibility of these industries and reducing the cost incurred by them significantly.

The network of TDAs 110 also has a TDA package that is a fully integrated component of the system 100. The network of TDAs 110 eliminates the First Mile and the Last Mile problem for the shipper and the receiver and provides complete personal privacy for the receiver. The network of TDAs 110 also enables community small businesses to have a new and significant income if they sign up with the system 100 as a TDA.

Once a consumer shows an interest to select a small business as their TDA, the small business is invited by a System Operator to become an authorized TDA for making parcel deliveries and is asked to satisfy some requirements to enable them to serve as a TDA. Candidate TDAs are technologically enabled and get networked with the system 100 by the System Operator. These requirements may include, for example, basic training for delivery handling, certification of utilization of the software provided by the System Operator, providing enough physical temporary storage area, providing sufficient personnel, insurance coverage for possible losses due to negligence and a limited performance bond to cover possible losses as a result of negligence. After the small business fulfills the requirements, it will be admitted into the system 100 as a TDA for a limited number of consumers in a defined neighborhood, such as in a one-mile radius.

As such in one embodiment of the disclosure, the following steps are configured to be performed using the system 100:
a—The recipient creating and establishing a unique identification code.
b—The recipient selecting and entering a TDA into the system 100.
c—The selected TDA is established in the system 100 per the system protocols.
d—The delivery courier is notified to deliver the packages to the TDA for package destined for the recipient.

In some embodiments, when seasonal surge happens, such as, but not limited to, during Black Friday, Christmas season and other similar occasions, the number of parcels to be delivered increases by many folds compared to normal days. In such cases, the delivery industry resources are unable to cope with the surges in the demand. Under such circumstances, the network of TDAs 110 conveniently handles such surges without any extra investment. This is further illustrated as follows.

On one hand, the TDAs create additional storage area in their store in anticipation of an upcoming surge in incoming and outgoing shipments.

On the other hand, the courier companies make several bulk deliveries every day to finish the large volume of the parcels to be delivered.

The consumer is then able to receive their incoming shipments without delay by picking up their parcels from their own TDAs or asking for delivery to their final locations.

The TDAs are satisfied since they will have much more extra income because of the surge in the number of parcels. The courier companies are also satisfied since they will be able to cope with the surge without any delays in their deliveries or picking up the new shipments.

In accordance with various embodiments, the network of TDAs 110 may also be utilized for delivery of things other than parcels, such as delivery of cash from a consumer's bank account to the consumer or from one consumer to another consumer, where each consumer could possibly be served by different TDAs in the system 100 around the world. Such a system would transform the concept of money transfer or ATM services offered by banks. Going to an ATM machine to obtain cash would be replaced by delivery of needed cash through the system 100 utilizing the network of TDAs 110.

The network of TFAs 112 are selected by consumers from existing banks or other financial institutions or special businesses started up for this purpose. The TFAs execute financial transactions on the request of consumers who appoint them as their TFAs. The TFAs execute financial transactions and make payments on behalf of the consumers without disclosing the consumers' identity or personal financial information and in response, charge the account or the credit card of the consumers. As such, the TFAs enable the consumers to make purchases without disclosing any personal or financial information to third parties.

In accordance with an embodiment, when a consumer is using a TDA for their delivery services, courier companies are expected to provide a portion of discount for the shipping charges since the courier companies save so much due to elimination of the First Mile and the Last Mile problem, which in turn reduces the cost to the end users. Thus, in this model, consumers are encouraged to assign a TDA, and small businesses are motivated to sign up as a TDA. The expected mode of revenue collection is as follows.

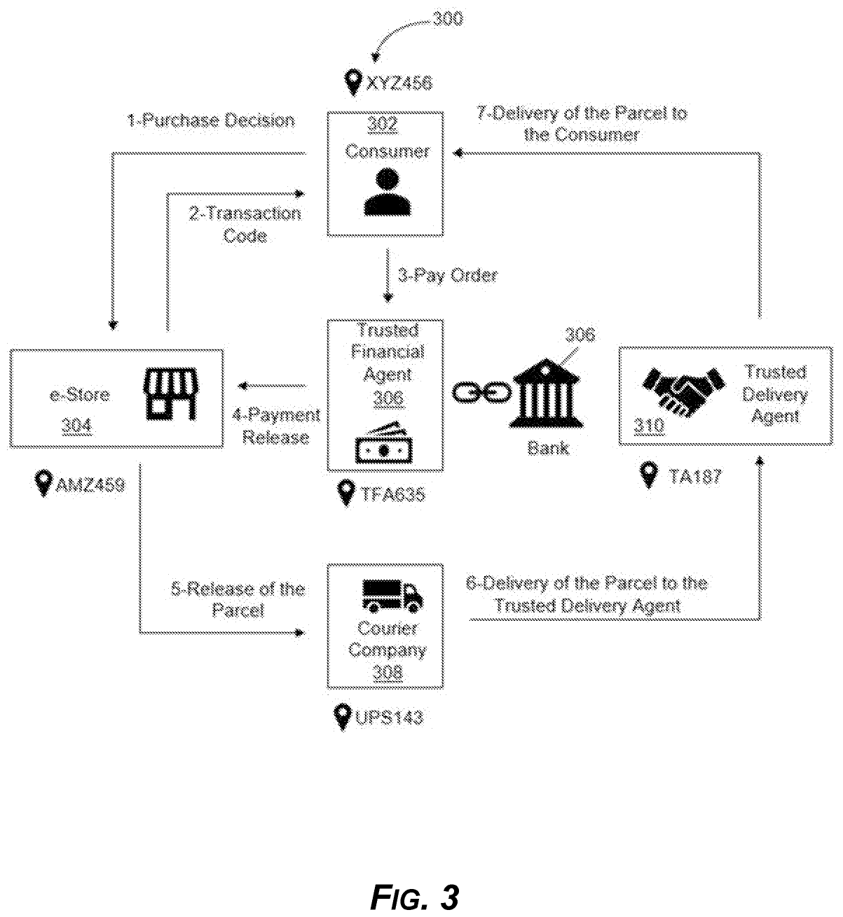

A consumer pays a courier company for the courier services which includes payments for a TDA. For example, the TDA gets 3$ per package for “small” parcels and 7$ for larger parcels from the courier company. As soon as the parcel is delivered to the TDA of the consumer, the consumer is informed through a messaging system of the system 100 that their parcel has been delivered to their TDA as per their instructions. The consumer is then offered two options: whether the consumer would like the parcel to be delivered to the consumer's location within an allowed time window or whether the consumer would like to pick it up from the TDA himself rather than waiting for the parcel to be delivered to their final location, in which case the consumer may be refunded 1$ which the consumer can use in future shipments. Alternatively, this may be formulized such that the payment for delivery services between the TDA and the consumer is settled partially or fully between the TDA and the consumer. The process of private purchase and providing delivery services for consumers is further illustrated in conjunction with FIG. 3.

In accordance with an exemplary embodiment, the Blockchain and contract-based system 114 is configured to facilitate financial settlements using digital tokens, wherein one or more contracts are established between the user and one or more of the plurality of agents 108a-108n. A contract may be established as a smart contract.

The Blockchain and contract-based system 114 enables settlements of billions of transactions every day and at every instant. The Blockchain and contract-based system 114 settles everything and authorizes the payments among millions of stakeholders around the world. The Blockchain and contract-based system 114 is used for all financial settlements and for delivery authentication in a comprehensive manner.

In accordance with an exemplary embodiment, the system 100 utilizes the network of TDAs 110 and the network of TFAs 112 for enabling money transfer or cash transfer from consumers' banks to the consumers or from consumers to consumers, where each consumer could possibly be served by different TDAs in the system 100 around the world.

A consumer utilizes a TFA (for example, the consumer's bank, if it is already a part of the system 100) and a TDA to withdraw cash without going to his bank or an ATM. The associated steps are enumerated below.

Using the online account on the system 100, the consumer asks his bank to pay, for example, 500$ to the TDA.

The bank then transfers for example, 505$ to the TDA's account, where, for example, 5$ is the commission of the TDA.

In an ensuing step, the TDA is notified of the transfer of funds for the consumer. The consumer can also have the cash delivered to their address or can directly pick up the cash from their respective TDA. In this case, the consumer gets a rebate, for example, of 1$, which is credited to the consumer's account.

In accordance with another exemplary embodiment, the system 100 enables a consumer to transfer money from his or her TFA account to anyone with a TDA. The associated steps are enumerated below.

Using the online account of the system 100, the consumer asks his bank to pay, for example, 500$ to the TDA of a recipient to whom he wants to transfer funds using the unique ID of the recipient and a TDA of the recipient.

The bank then transfers, for example, 505$ to the TDA's (of the recipient) account, where, for example, 5$ is the commission of the TDA.

The TDAs are also provided a notification of the transfer of funds for the consumer associated with the system 100. The consumer can also have the cash delivered to their address or can directly pick up the cash from their respective TDA. In this case, the consumer gets a rebate, for example, of 1$, which is credited to the consumer's account. The money transfer is possible within national borders as well as international borders using the Blockchain and contract-based system 114.

The information sharing module 116 may comprise suitable logic, and/or interfaces, that may be configured to enable delivery of multi-dimensional information to one or more agents of the plurality of agents 108a-108n. The multi-dimensional information may include, but are not limited to, pictures, videos, waypoints, experiences of previous agents, written or audio explanations, time of availability or approach vector information of an address or location, navigation and guidance information on how to reach agents at any given time instant or combinations thereof

The information sharing module 116 may be configured as an application that can be downloaded on a user's computing device such as, but not limited to, a mobile device, a smartphone, a laptop, a computer, a tablet or other virtual machines or embedded devices. The information sharing module 116 enables utilization of all relevant information encoded under a “short code” in a secure and private manner. The information may include, but are not limited to, basic contact information of the user such as postal addresses and phone numbers, the user's images/photos, 3D addresses/coordinates (address, space and time dimensions), biometrics such as, but not limited to, fingerprints, images/pictures of the user's location, building, entrance/door, pictures/videos of the location/landmarks/way points to the user's location, navigational aids, information about proxy contacts of the user to reach out to in case of difficulty, barcodes, square codes, TDAs and Radio Frequency (RF) IDs.

In accordance with an embodiment, the multi-dimensional information is stored in a database system 118 which includes one or more databases working in coordination with the information sharing module 116. Various versions of the database system 118 may be implemented without limiting the scope in context of the information sharing module 116.

In accordance with an embodiment, the database system 118 is configured to store the multi-dimensional information as one or more unique information bundles of a user. The one or more unique information bundles for the user are generated by encapsulating/encoding a plurality of information items associated with the user into a ‘short code’. The plurality of information items may include, but are not limited to, basic contact information of the user, the user's images/photos, 3D/4D addresses/coordinates of the user's location, the user's biometrics information, images/pictures of the user's location, building, entrance/door, pictures/videos of the location/landmarks/way points to the user's location, navigational aids, information about proxy contacts of the user to reach out to in case of difficulty, barcodes, square codes, TDA IDs and Radio Frequency (RF) IDs, and an available time or schedule of the user.

In accordance with an embodiment, the one or more unique information bundles are stored in an information wallet under a unique information identifier (ID). The information wallet refers to an information sharing account of the user. The user's information sharing account is associated with a unique name for sharing an identity of the user (such as, for example, @johndoe). An information sharing identity can also be considered as a unique name for the information wallet. The users can store their own unique information bundles in information wallet to be shared with other users, or the information wallet can also store information bundles shared with the user by other users.

The information wallet of the information sharing module 116 serves as an information sharing platform for many services in CEP (Courier, Express, Parcel) and Transportation industry and Fintech services. The information wallet includes information proliferated through multiple sources, mainly the consumer and ID owner. In an embodiment, a 3D addressing schema is illustrated which resides in the information wallet to be used as a local 3D schema to facilitate the services of the system 100. Other 2D/3D addressing schemas may also be hosted/endorsed in the information wallet to be processed or converted interchangeably.

In accordance with an exemplary embodiment, the information sharing module 116 is configured to deliver 3D coordinate and time information using the 3D navigational and addressing schema 120. The 3D navigational and addressing schema 120 stores one or more navigational directions and/or movement vectors from one location to another in a series of addressing components.

In an embodiment, the 3D navigational and addressing schema 120 is used to provide navigational directions from one location to another in a series of addressing components for drones and other vehicles. From Building A to Building B or from City A to City B, a set of 3D addressing schemas with movement vectors are provided to a requesting device or vehicle. In this case, the information sharing module 116 is configured to reveal partial information or 3D addresses for supporting privacy and security of the personal information or address information.

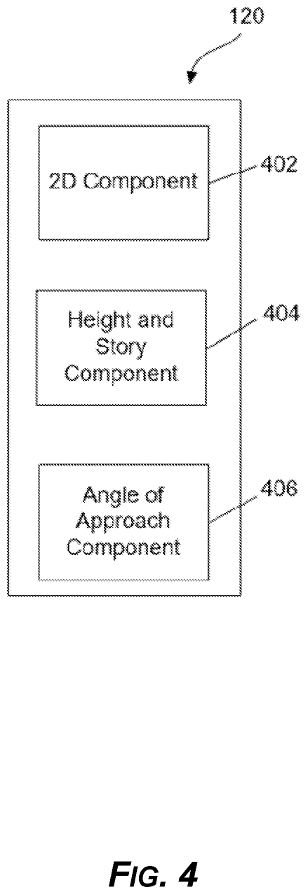

The 3D navigational and addressing schema 120 and the series of addressing components are further described in conjunction with FIG. 4.

In accordance with an embodiment, the information sharing module 116 is configured to share one or more information bundles of the user with one or more parties. The one or more parties may include, but are not limited to, service providers, delivery agents, TDAs, other users, non-users and machines.

In accordance with another embodiment, the information sharing module 116 is configured to enable dissemination of information resident within a unique information bundle selectively when needed. The information sharing module 116 is further configured to share one or more information items of the plurality of information items encapsulated/encoded in a unique information bundle with the one or more parties.

In accordance with yet another embodiment, the information sharing module 116 includes a communications and delivery protocol which is configured to share one or more information items encapsulated/encoded in a unique information bundle with the one or more parties. For instance, the communications and delivery protocol is configured to share an “Interactive Address” or “Connected Address” or “Live Address” with the one or more parties such as, but not limited to, service providers. This enables the service providers to have scheduled (time-based) or updated location information from an ID owner whenever appropriate through the information sharing module 116. This also enables the service providers reach the location of the user based on the provided availability information. Furthermore, the information sharing module 116 enables both the consumers and service providers to update the shared information when required.

Similarly, continuously changing location information is instantaneously shared using the communications and delivery protocol to provide “Live Address or Connected Address” to enable services such as “delivery on the move”, where the consumer is not in a fixed location, and is on the move. Such a property is used in applications such as, but not limited to, smart cars, smart traffic or coordinated land base or airborne traffic applications.

In accordance with yet another embodiment, the information sharing module 116 includes a need to know basis delivery protocol which is configured to disseminate only a portion of an information item encapsulated/encoded in a unique information bundle on a need to know basis with each of the one or more parties. Thus, the need to know basis delivery protocol enables hierarchical dissemination of the information for effective completion of services or tasks.

In accordance with an embodiment, a natural result of the need to know basis delivery protocol implementation in the information sharing module 116 is that, when a shipment is to be initiated (sending end) from Location A to Location B, the exact/optimal routing information and pricing is generated at the “receiving end” since the sender is not provided with the detailed final location information of the receiver. For instance, if it is an international shipment, the courier services at the sending end know of only the country of the receiver. At this stage, since the courier services do not have knowledge of the state, city, district, village or any other information, they are unable to figure out the chain of logistics intermediaries to be used to go from Location A to Location B.

When a request is received from a consumer, the optimal routing information to deliver the parcel to the consumer is generated at the receiver's end and is distributed to all of the intermediaries on a need to know basis using the need to know basis delivery protocol. If there is a need to revise the optimal routing information for any reason, the revision is also done at the receiving end point (receiving end). Also, the pricing for the shipment is also done in the courier service's system at the receiving end and communicated to the shipping party. As such, two targets are achieved. Firstly, the personal private information of the consumer is held confidential. Secondly, the optimal routing information is provided as a part of the information shared by information sharing module 308, which will prevent shipments from getting stuck at wrong logistics points.

In accordance with still yet another embodiment, the relevant information shared using information sharing module is the mailbox number or a drop-in location.

In accordance with yet another embodiment, the information sharing module 116 also includes an internet and mobile technologies component in communication with GPS and navigation capabilities of the user's computing device for tracking the user's current location and automatically updating one or more information items associated with the one or more unique information bundles. The user is also enabled to manually update any information associated with the one or more unique information bundles of the user's account. Thus, the one or more unique information bundles are unique to a user and not to the user's location.

In accordance with yet another embodiment, the relevant information shared using the information sharing module 116 are the IDs of TDAs. For instance, if a customer is using a TDA for delivery of a shipment, the customer will not need to share any other information other than the TDA's ID with information of where the customer wants the delivery to be made. A TDA is selected by the user from the network of TDAs 110. The network of TDAs 110 is selected from a group consisting of, but not limited to, neighborhood small businesses, a household, mobile distribution network, and any local qualified party willing to be assigned as TDA, to enable either a First Mile or Last Mile delivery.

TDA IDs associated with TDAs are shared for final delivery of a shipment/parcel to a consumer and for drone deliveries. For example, air traffic approaching coordinates embedded in a TDA ID are used as a part of information sharing for drone deliveries.

In an embodiment, TDAs are included as partners of the system 100 and are “crowd sourced” through the system 100. The TDAs are authorized by an end user and will have to comply with the standards approved and set by the system 100 to start functioning as TDAs. This provides the system 100 a huge leverage over TDA partners and courier companies.

The consumer's exact delivery information is made available to the TDA or the TDA naturally has such knowledge about the consumer since they are in the same neighborhood and physically interact for their natural daily transactions. Thus, the system 100 utilizes the network of TDAs 110 to provide the solution and remedy to the First Mile and the Last Mile problem.

The TDA property transforms community small businesses such as, but not limited to, the grocery shop, the tailor, the butcher, the baker, or a shop just founded for this purpose, into “the unified Last Mile and First Mile solution partner” for all the players in the courier industry. Through the system 100, a shipper, a receiver and a courier company are “enabling” and “authorizing” TDAs to pick up deliveries from courier service industries such as, but not limited to, DHL, FedEx, UPS, PTT, and the authorization is being done by the recipient through the system 100.

In accordance with an embodiment, the system 100 also enables unified tracking by enabling the customer/user to track all their incoming and outgoing deliveries within the system 100 from their information sharing account regardless of a sender or carrier.

Further, the system 100 enables the customer to prevent unauthorized deliveries at the source before they are shipped from their information sharing account. Prompts/notifications are sent to the customer regarding shipment to be delivered and delivery is initiated only upon receiving authorization from the customer.

In accordance with another embodiment, the system 100 presents a solution for the fraud problem in the delivery industry by providing a digitally secure, end-to-end system that enables traceability of the shipment at any point and tracks and maintains digital accountability of who receives the shipment at each junction. Also, for the Last Mile, the system 100 enables a courier or courier agent to be able to make deliveries to an alternate person in an alternate location or to a corresponding TDA on their behalf (without leaving the shipment at the doorstep), in case an intended recipient is not available to receive the shipment. This way, the intended recipient will not be able to deny that they did not receive the shipment.

Furthermore, to provide improved delivery services in the delivery industry, the plurality of agents 108a-108n of the system 100 are redefined with memory+pre-processing capability/“experience”+capability to share/communicate/store experience information with other neighboring agents up to its level, using the AI/ML component 122. In this context, the plurality of agents 108a-108n are referred to as ‘nodes’.

The nodes thus share perfect routing information based on experience or pre-computation using the AI/ML component 122. This enables nodes to share the required information with one or more parties, intended for delivery to their location. Thus, the system 100 uses existing knowledge/experience of a consumer to determine navigation or guidance information of how to reach the consumer at the consumer's location. This can be formulated as an algorithm as follows, the algorithm being augmented with AI/ML.

In a first step, every node has the optimal knowledge (or resources to be able to compute the optimal knowledge effectively) of how to reach the node in a neighborhood for any given time instant. This neighborhood could be quite large and/or a mile wide.

Every node then propagates this optimal routing information with the neighboring nodes as an experience or pre-computed knowledge. If there is a request to reach a consumer's location, the consumer makes all the information available to a requester.

In accordance with an embodiment, the AI/ML component 122 further includes an algorithm for optimal routing during the delivery, where knowledge/experience vested in the network is utilized and shared with other nodes.

In accordance with another embodiment, the AI/ML component 122 further includes an algorithm for optimal routing during the delivery, where knowledge/experience from consumers are utilized as “crowd source” information and is shared with other nodes.

The access system 124 may comprise suitable logic, interfaces, and/or code that may be configured to execute the instructions stored in the memory 102 to implement various functionalities of the system 100 in accordance with various aspects of the present disclosure. The access system 124 is configured to control entry of an agent into the user's premises. The access system 124 is further configured to generate a one-time pass to enable the agent to enter the user's premises to deliver a product and/or service, wherein the one-time pass is associated with a time period for entry of the agent.

The access system 124 enables a visitor to contact a person having an account with the system 100 to request a pass for visiting the person in a specific time period. The visitor may include, but is not limited to, a delivery agent delivering a package/parcel/shipment to the person.

Once the visitor is verified, the visitor is sent a square code pass to his/her smart phone via the access system 124.

The visitor then enters the building and scans the square code to pass the controlled entry. At this instance, the host/person receives an instant notice via the access system 124 that the visitor has arrived.

After the visit when the visitor leaves the building, the one-time pass is invalidated.

The access system 124 may be used for controlled entry into places such as, but not limited to, cinemas, concerts, exhibitions, fairs, and Airbnb type applications. The access system 124 may also be used for other purposes not necessarily listed here.

In some embodiments, the system 100 may include a voucher system configured to authorize disbursement of cash for payments towards goods or services purchased by a consumer. A voucher identifies what is to be paid for, the amount to be paid, and the account number to be charged. Once this voucher is approved, the voucher system is authorized to issue payment.

In some other embodiments, an online marketplace or an e-commerce site is provided where product or service information is provided by multiple third parties. These online marketplaces are the primary type of multichannel ecommerce and serve to streamline the production process.

FIG. 2 is a flowchart of a process for addressing the First Mile problems in the delivery industry in accordance with an exemplary embodiment of the disclosure. Referring to FIG. 2, there is shown a flowchart 200.

At 202, request, by a consumer, shipment pick up from a courier company. The consumer requests an outgoing shipment pick up from the courier company using online services of the courier company. The consumer is using the system 100 of the present disclosure to which the courier company is also integrated with.

At 204, enable the courier company to make online reservation with a TDA of the consumer by generating a parcel reservation code. The courier company quotes a price, receives the payment and makes online reservation by generating a parcel reservation code, with the TDA of the consumer to pick up the parcel from the consumer or to deliver the parcel to the TDA for delivery to the consumer.

At 206, receive, by the TDA, outgoing shipment from the consumer as per the parcel reservation code. The TDA receives the outgoing shipment from the consumer as per the parcel reservation code and as agreed between the courier company and the consumer.

At 208, repeat steps 202-206 for returned/rejected shipments, with no online payment involved.

At 210, enable the consumer to go to the TDA directly to initiate a new shipment or to return/reject shipments. In some cases, some courier companies may find the online steps unnecessary and allow the consumer to go to the TDA directly to initiate a new shipment or to return/reject shipments. Such a service greatly reduces (or ideally eliminates) the job of the courier company for the First Mile.

FIG. 3 is a flow diagram illustrating a process of private purchase and delivery in a delivery industry in accordance with an exemplary embodiment of the disclosure. Referring to FIG. 3, there is shown a flow diagram 300 which depicts a consumer 302, an e-store 304, a TFA 306 (for example, a bank), a courier company 308, and a TDA 310.

The process steps 1-7 enumerated in the flow diagram 300 are as follows.

1-Purchase Decision. The consumer registers with the system 100 of the present disclosure without disclosing their identity explicitly, for instance, say the consumer's identity is GX456. The consumer is assigned a random identity for any transaction to prevent identity-based profiling. The consumer then selects goods to purchase and agrees on the price at the e-store 304 which is an online shopping store, which is also a part of the system 100.

2-Transaction Code. A Transaction Code is generated by the e-store 304 (seller), which indicates who the buyer is and an amount to be paid. This Transaction Code is shared with the consumer 302.

3-Pay Order. The consumer 302 places the order.

4-Payment Release. When the consumer 302 places the order, it triggers their TFA 306 to settle the payment on their behalf in reference to the Transaction Code and charge the consumer's account or the credit card. Similarly, the courier company 308 is also paid by the TFA 306 and the identity of the TDA 310 is shared with the courier company 308.

5-Release of the Parcel. The courier company 308 picks up the package from the e-store 304 (seller).

6-Delivery of the Parcel to the TDA. The courier company 308 delivers the package to the TDA 310 appointed by the consumer 302.

7-Delivery of the Parcel to the consumer. The consumer 302 then receives the parcel/goods from the TDA 310.

FIG. 4 is a diagram that illustrates a 3D navigational and addressing schema for enabling delivery of 3D coordinate and time information in accordance with an exemplary embodiment of the disclosure. Referring to FIG. 4, there is shown the 3D navigational and addressing schema 120 which includes a 2D component 402, a height and story component 404, and an angle of approach component 406.

The height and story component 404 includes information pertaining to a height and a number of stories in a building to be addressed with each story level.

The angle of approach component 406 for drones and other vehicles includes planar movement definition for a series of moves in case of a need for stabilization or an approach angle to a building or a moving object. The angle of approach component 406 includes information pertaining to an angle for any movement towards a specific movement vector through an angle of perimeter and height.

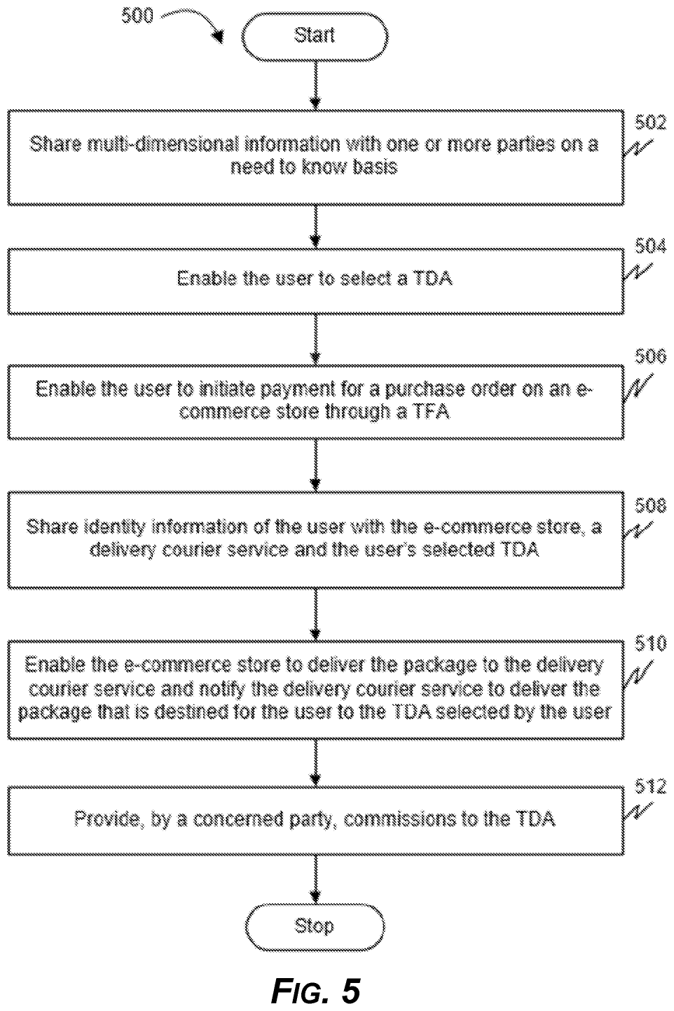

FIG. 5 is a flowchart that illustrates a method for facilitating secure delivery of products and/or services to a user using the system in accordance with an exemplary embodiment of the disclosure. Referring to FIG. 5, there is shown a flowchart 500 for facilitating secure delivery of products and/or services to a user using the system 100 of the present disclosure.

At 502, share multi-dimensional information with one or more parties on a need to know basis. The information sharing module 116 shares multi-dimensional information associated with the user on a need to know basis.

At 504, enable the user to select a TDA. To remedy the First Mile and the Last Mile problem, the user selects and/or enters a TDA in the system 100 to register the network of TDAs 110. A selected TDA is established in the system 100 as per system protocols.

At 506, enable the user to initiate payment for a purchase order on an e-commerce store through a TFA. The user is enabled to initiate payment for a purchase order on an e-commerce website through its TFA (for example, the user's bank) selected by the user.

At 508, share identity information of the user with the e-commerce store, a delivery courier service and the user's selected TDA. Upon successful completion of the payment, identity information of the user is shared with the e-commerce store, the delivery courier service and/or the user's selected TDA. In an embodiment, a TDA ID is also shared as part of the information with the e-commerce store and the delivery courier service.

At 510, enable the e-commerce store to deliver the package to the delivery courier service and notify the delivery courier service to deliver the package that is destined for the user to the TDA selected by the user.

At 512, provide, by a concerned party, commissions to the TDA. Once the TDA delivers the package to the user, commissions to the TDA are paid by the concerned party.

The present disclosure is advantageous in that it provides an improved system which addresses the challenges in the delivery industry associated with existing address conventions, the First Mile and the Last Mile problem, diverse delivery requests, personal problems/issues in online purchase and delivery systems, drawbacks in identity-based access systems/ticketing systems, and changing delivery technologies (for example, drone deliveries).

The system of the present disclosure encodes all relevant information associated with a user under a ‘short code’ and generates unique information bundles which uniquely identify the user and not the user's location. Therefore, even if the user's postal address/location changes, the information can be updated under a unique ID or an information account of the user.

Further, the system of the present disclosure enables storing addresses with space and time dimensions (4D addresses) and assigns varying security levels to enable sharing of information associated with the IDs on a contextual or conditional basis using the hierarchical need to know basis delivery protocol. A new schema is used for addressing a specific point at any location of the world in longitudinal, horizontal and vertical indexing along with the services to navigate around obstacles using time-based address vectoring for any equipment such as, but not limited to, airborne delivery vehicles, automated airborne vehicles, automated and unautomated ground vehicles.

Furthermore, the system of the present disclosure enables users to perform unified tracking of their deliveries from their account, which enables users to track their incoming and outgoing shipments within the system 100, no matter which courier service is taking care of the actual delivery. The users can activate an authorization feature through their account so that no shipment can be initiated without prior authorization of the users. Such a property also prevents delivery of dangerous/illegal shipments. The users can have a requirement for authorization of all incoming shipments or can have a white-list and require that anybody else not on the white-list get authorization before sending a shipment to the user.

The system of the present disclosure also presents a solution for the fraud problem in the delivery industry by providing a digitally secure, end-to-end system that enables traceability of the shipment at any point and tracks and maintains digital accountability of who receives the shipment at each junction. Also, for the Last Mile, the system of the present disclosure enables a courier or courier agent to be able to make deliveries to an alternate person in an alternate location or to a corresponding TDA on their behalf (without leaving the shipment at the doorstep), in case an intended recipient is not available to receive the shipment. This way, the intended recipient will not be able to deny that they did not receive the shipment.

The present disclosure also solves the optimal routing problem prevalent in the delivery industry. The already available knowledge/experience in the network is utilized effectively and shared with other nodes instead of each node having to recompute them. Further, “crowd source” information from other consumers is used for providing improved delivery resources to serve the consumers better, at the same time reducing the consumption of computational resources.

Further, the system of the present disclosure utilizes the TDA network to provide a solution and remedy the inefficiencies and difficulties of the First Mile and the Last Mile delivery, thus avoiding missed deliveries, returns, losses and burdensome schedule of couriers. The TDA network provides a solution for the First Mile and the Last Mile delivery problem for the parcel delivery industry and ensure a smooth First Mile and Last Mile delivery to e-commerce delivery services. Thus, the shipments/parcels move through the next stages of the C2C or B2C supply chain in a quick, efficient, and hassle-free manner. The TDA network also provides a solution for the same day delivery problem. Furthermore, the TDA network replaces the ATM cash delivery system for the banks.

The system of the present disclosure also provides a solution to enable consumers to be able to make private purchases over the Internet and have them delivered to them without being forced to disclose any personal and financial information.

Furthermore, identity-based access/ticketing systems integrated with the system of the present disclosure are more efficient in controlling entry of visitors with use of a one-time time-based passcode, for purposes such as visits or delivery of parcels, shipment, or package.

The system for facilitating delivery of products and/or services to a user is disclosed. The system includes a plurality of agents to facilitate delivery of one or more products and/or services to the user, a network of TDAs, the network of TDAs selected from the plurality of agents proximate to a delivery location of the user, a network of TFAs, the network of TFAs selected from a plurality of financial institutions, and an information sharing module. the plurality of agents comprise at least one of service providers, electronic retailers or e-retailers, marketplace, e-stores, delivery agents, TDAs, TDA networks, other users, non-users, vehicles, machines, vessels, mobile devices, service providers, vehicle drivers, automation services, freight services, inhouse storage and concentration centers or combinations thereof

The network of TDAs is selected from a group consisting of existing neighborhood small businesses, a household, a mobile distribution network, a business started for this purpose or any local qualified party willing to be assigned as TDA, proximate to a delivery location of the user.

The network of TDAs acts as an integral part of common parcel and other delivery services, wherein the network of TDAs takes over the First Mile and the Last Mile of a delivery supply chain.

In accordance with an embodiment, a TDA enables transfer/delivery of cash from the user's funds transfer account to a recipient, wherein the funds transfer account is at least one of a credit card account, a bank account, a debit card account, a gift card account or any other similar financial services.

The network of TFAs is selected from a group consisting of existing banks, financial institutions, and special businesses started up to conduct financial transactions on behalf of the user.

A TFA is triggered to settle a payment on behalf of the user in reference to a transaction code, wherein the TFA settles the payment without disclosing the user's identity or personal financial information and in response, charges an account of the user, wherein the account is at least one of a credit card account, a bank account, a debit card account, a gift card account or any other similar financial services and wherein the transaction code is generated by an agent and comprises information pertaining to the user, an amount for the payment and a smart contract that includes terms of payment released to the user.

In accordance with an embodiment, a Blockchain and a contract-based system for facilitating financial settlements using digital tokens. One or more contracts are established between the user and at least one of the plurality of agents. A contract may be established as a smart contract.

The information sharing module is configured to enable delivery of multi-dimensional information to one or more agents of the plurality of agents. The delivery of the multi-dimensional information includes delivery of at least one of pictures, videos, waypoints, experiences of previous agents, written or audio explanations, time of availability or approach vector information of an address or location, navigation and guidance information on how to reach agents at any given time instant or combinations thereof. Each agent of the plurality of agents maintains the multi-dimensional information as pre-computed knowledge/experience and propagates the pre-computed knowledge/experience to one or more neighboring agents of the plurality of agents. In accordance with an embodiment, the system further includes an AI/ML component configured to utilize previous data to determine knowledge/experience of previous users to facilitate delivery of the one or more products and/or services to the user.

In accordance with an embodiment, the information sharing module is configured to deliver 3D coordinate and time information using a 3D navigational and addressing schema. The 3D navigational and addressing schema stores at least one of navigational directions and/or movement vectors from one location to another in a series of addressing components. The series of addressing components comprises a 2D component, a height and story component and an angle of approach component for drones and other vehicles. The height and story component includes information pertaining to a height and a number of stories in a building to be addressed with each story level. The angle of approach component for drones and other vehicles comprises planar movement definition for a series of moves in case of a need for stabilization or an approach angle to a building or a moving object, wherein the angle of approach component comprises information pertaining to an angle for any movement towards a specific movement vector through an angle of perimeter and height.

The information sharing module is further configured to share at least one TDA ID, wherein a TDA ID comprises information corresponding to a TDA selected by the user from the network of TDAs and a TFA is selected by the user from the network of TFAs integrated in the system, wherein the TFA is configured to carry out financial transactions and/or financial services between the user and one or more agents on behalf of the user.

In accordance with an embodiment, the system further includes an access system configured to control entry of an agent into the user's premises, wherein the access system is configured to generate a one-time pass to enable the agent to enter the user's premises to deliver a product and/or service, wherein the one-time pass is associated with a time period for entry of the agent.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus/devices adapted to carry out the methods described herein may be suited. A combination of hardware and software may be a general-purpose computer system with a computer program that, when loaded and executed on the computer system, may control the computer system such that it carries out the methods described herein. The present disclosure may be realized in hardware that comprises a portion of an integrated circuit that also performs other functions. The present disclosure may also be realized as a firmware which form part of the media rendering device.

The present disclosure may also be embedded in a computer program product, which includes all the features that enable the implementation of the methods described herein, and which when loaded and/or executed on a computer system may be configured to carry out these methods. Computer program, in the present context, means any expression, in any language, code or notation, of a set of instructions intended to cause a system with information processing capability to perform a particular function either directly, or after either or both of the following: a) conversion to another language, code or notation; b) reproduction in a different material form.

While the present disclosure is described with reference to certain embodiments, it will be understood by those skilled in the art that various changes may be made, and equivalents may be substituted without departure from the scope of the present disclosure. In addition, many modifications may be made to adapt a particular situation or material to the teachings of the present disclosure without departure from its scope. Therefore, it is intended that the present disclosure is not limited to the particular embodiment disclosed, but that the present disclosure will include all embodiments that fall within the scope of the appended claims.

What is claimed is:

1. A system for facilitating delivery of products and/or services to a user, the system comprising:
a plurality of agents to facilitate delivery of one or more products and/or services to the user;
a network of Trusted Delivery Agents (TDAs), wherein the network of TDAs is selected from the plurality of agents proximate to a delivery location of the user;
a network of Trusted Financial Agents (TFAs), wherein the network of TFAs is selected from a plurality of financial institutions; and
an information sharing module, wherein the information sharing module is configured to enable delivery of multi-dimensional information to one or more agents of the plurality of agents,
wherein each agent of the plurality of agents maintains the multi-dimensional information as pre-computed knowledge/experience and propagates the pre-computed knowledge/experience to one or more neighboring agents of the plurality of agents,
wherein the information sharing module is further configured to share at least one TDA ID, wherein a TDA ID comprises information corresponding to a TDA selected by the user from the network of TDAs, and
wherein a TFA is selected by the user from the network of TFAs integrated in the system, wherein the TFA is configured to carry out financial transactions and/or financial services between the user and one or more agents on behalf of the user.

2. The system of claim 1 further comprises a Blockchain and a contract-based system for facilitating financial settlements using digital tokens, wherein one or more contracts are established between the user and at least one agent of the plurality of agents.

3. The system of claim 2, wherein a contract is established as a smart contract.

4. The system of claim 1, wherein the plurality of agents comprise at least one of service providers, electronic retailers or e-retailers, marketplace, e-stores, delivery agents, TDAs, TDA networks, other users, non-users, vehicles, machines, vessels, mobile devices, service providers, vehicle drivers, automation services, freight services, inhouse storage and concentration centers or combinations thereof

5. The system of claim 1, wherein the delivery of the multi-dimensional information comprises delivery of at least one of pictures, videos, waypoints, experiences of previous agents, written or audio explanations, time of availability or approach vector information of an address or location, navigation and guidance information on how to reach agents at any given time instant or combinations thereof

6. The system of claim 1, wherein the information sharing module is configured to deliver three-dimensional (3D) coordinate and time information using a 3D navigational and addressing schema.

7. The system of claim 6, wherein the 3D navigational and addressing schema stores at least one of navigational directions and/or movement vectors from one location to another in a series of addressing components.

8. The system of claim 7, wherein the series of addressing components comprises a 2D component, a height and story component and an angle of approach component for drones and other vehicles.

9. The system of claim 8, wherein the height and story component comprises information pertaining to a height and a number of stories in a building to be addressed with each story level.

10. The system of claim 8, wherein the angle of approach component for drones and other vehicles comprises planar movement definition for a series of moves in case of a need for stabilization or an approach angle to a building or a moving object, wherein the angle of approach component comprises information pertaining to an angle for any movement towards a specific movement vector through an angle of perimeter and height.

11. The system of claim 1, wherein the network of TDAs is selected from a group consisting of existing neighborhood small businesses, a household, a mobile distribution network, a business started for this purpose or any local qualified party willing to be assigned as TDA, proximate to a delivery location of the user.

12. The system of claim 1, wherein the network of TDAs acts as an integral part of common parcel and other delivery services, wherein the network of TDAs takes over the First Mile and the Last Mile of a delivery supply chain.

13. The system of claim 1, wherein a TDA enables transfer/delivery of cash from the user's funds transfer account to a recipient, wherein the funds transfer account is at least one of a credit card account, a bank account, a debit card account, a gift card account or any other similar financial services.

14. The system of claim 1, wherein the network of TFAs is selected from a group consisting of existing banks, financial institutions, and special businesses started up to conduct financial transactions on behalf of the user.

15. The system of claim 1, wherein a TFA is triggered to settle a payment on behalf of the user in reference to a transaction code, wherein the TFA settles the payment without disclosing the user's identity or personal financial information and in response, charges an account of the user, wherein the account is at least one of a credit card account, a bank account, a debit card account, a gift card account or any other similar financial services and wherein the transaction code is generated by an agent and comprises information pertaining to the user, an amount for the payment and a smart contract that includes terms of payment released to the user.

16. The system of claim 1 further comprises an Artificial Intelligence/Machine Learning (AI/ML) component configured to utilize previous data to determine the knowledge/experience of previous users to facilitate delivery of the one or more products and/or services to the user.

17. The system of claim 1 further comprises an access system configured to control entry of an agent into the user's premises, wherein the access system is configured to generate a one-time pass to enable the agent to enter the user's premises to deliver a product and/or service, wherein the one-time pass is associated with a time period for entry of the agent.
